(19) United States
(12) Patent Application Publication
(10) Pub. No.: US 2011/0079225 A1
(43) Pub. Date: Apr. 7, 2011

(54) Personal Respiratory Filtration Apparatus

(76) Inventor: Robert B. Vole, Fisher Island, FL (US)

(21) Appl. No.: 12/898,805

(22) Filed: Oct. 6, 2010

Related U.S. Application Data
(60) Provisional application No. 61/249,004, filed on Oct. 6, 2009.

(51) Int. Cl. A62B 18/08

(52) U.S. Cl. 128/206.24

(57) ABSTRACT

A personal respiratory filter apparatus, having a substantially planer main body and a filter dependent thereon, functioning both as an article of every-day clothing in a scarf form, and as a support system for the breathable, treatable filter.

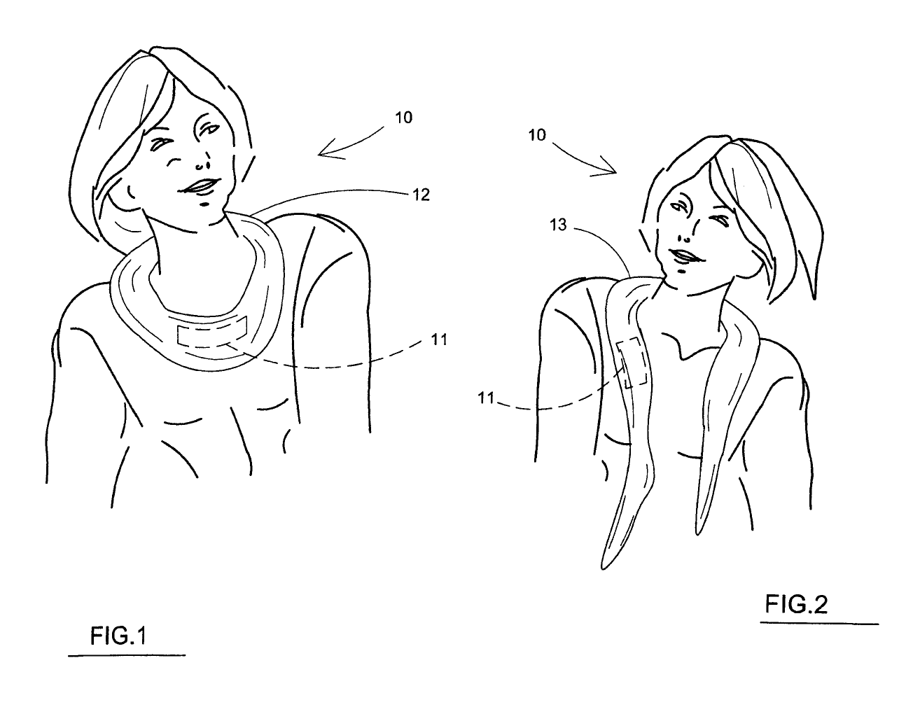

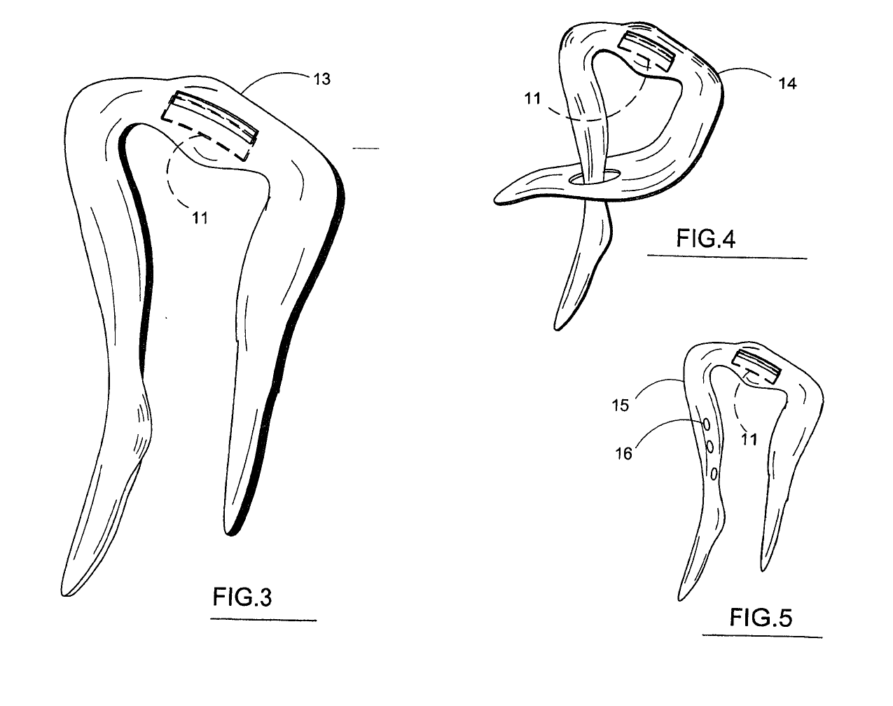

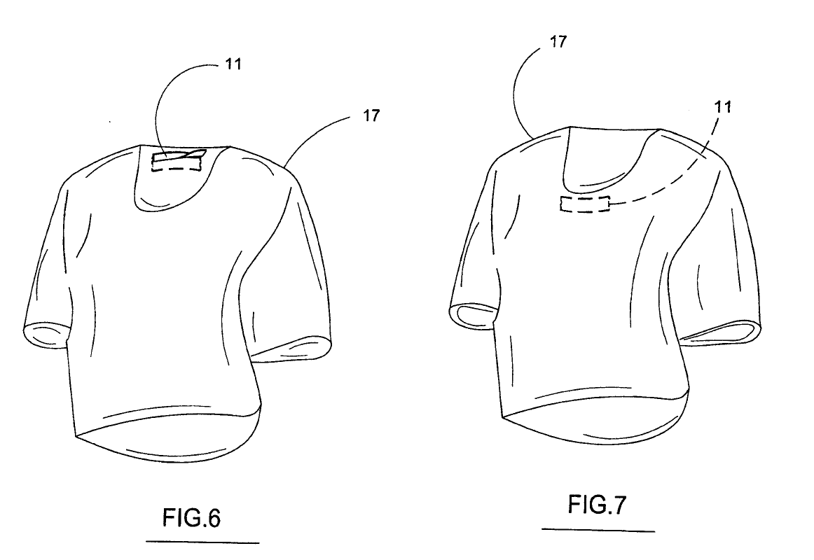

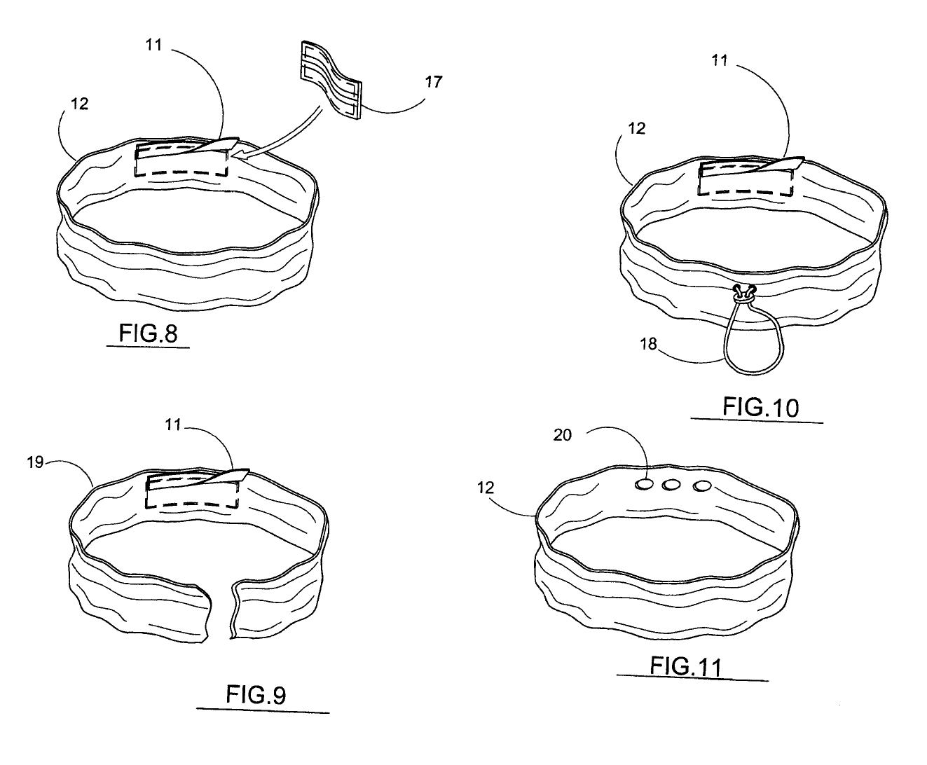

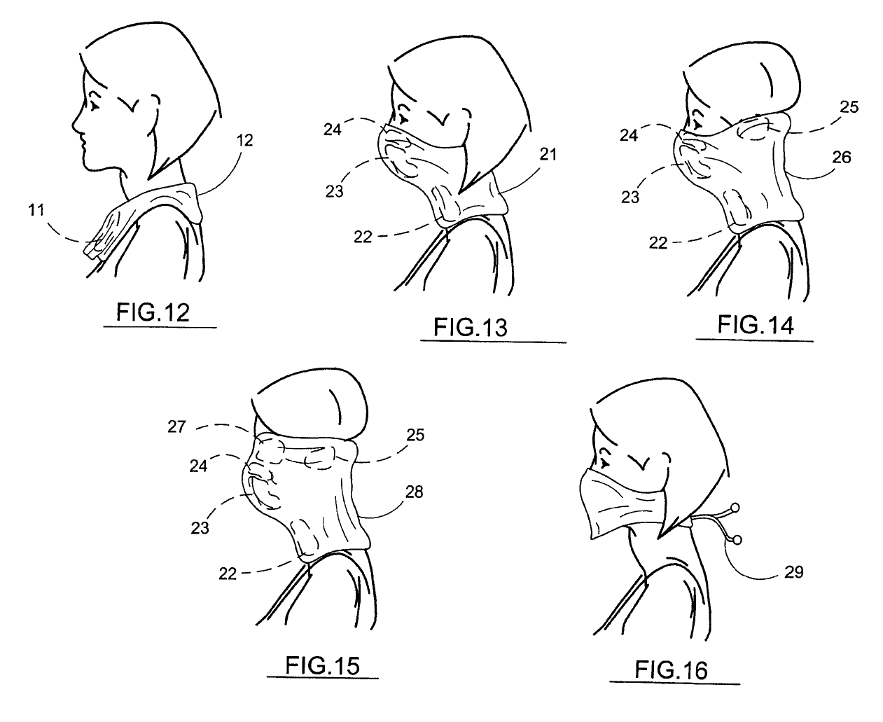

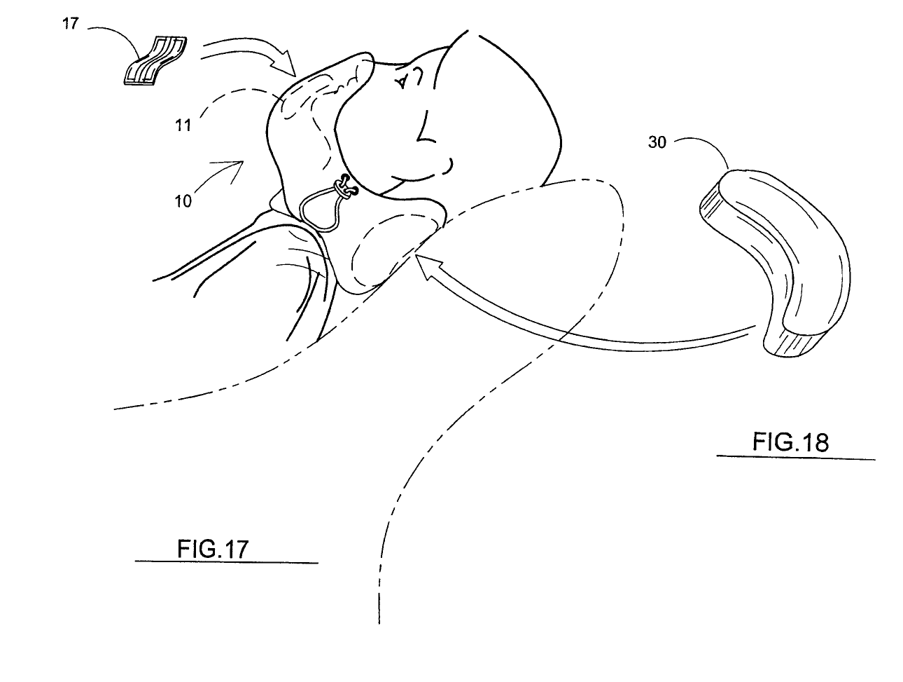

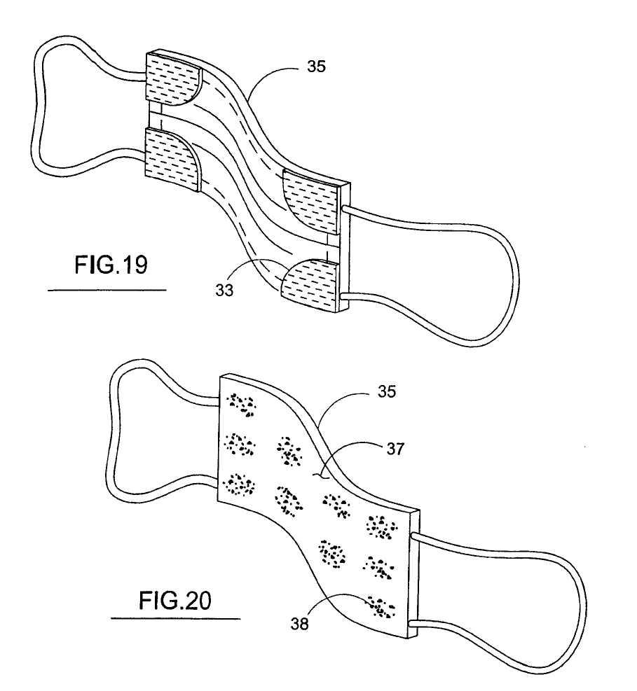

### INDEX TO RELATED APPLICATIONS

This application claims benefit to U.S. Provisional Patent Application No. 61/249,004 filed Oct. 6, 2009 the disclosure of which is incorporated herein by reference in its entirety.

### BACKGROUND OF THE INVENTION

1. Field of the Invention

The present invention relates to the use of masks to protect against harmful bacteria, and to the improvement of facemask filters. More specifically, it relates to a filter used alone or as a medical garment/scarf apparatus that is an article of clothing as well as a medical device. The filter, when used as a garment contains a removable, treatable or non-treatable facemask filter. The facemask filter can be worn individually or combined with the scarf apparatus to act as either or both of a barrier system and a treatment device. The filter system is for the treatment and/or prevention of common or less common diseases including but not limited to the common cold or influenza viruses and other viruses like SARS or H1N1. Additionally, the entire apparatus as well as the filter mask helps prevent and/or treats the spread of diseases, germs, allergens and all other airborne pathogens and foul odors.

2. Background of the Invention

The constant development of products within the health care field has resulted in a multitude of different treatments and methods to treat, prevent, and ameliorate many common and less common ailments, including, but not limited to, contagious viruses, infections and diseases. Many of the available treatments and methods target individuals who are already ill, thereby ignoring an entire population that struggles to protect itself from the possibility of infection. A variety of treatments, including painful injections have been made available, and preventative steps are taken each year, however these only offer either further chemicals entering the body, or are virtually ineffective prevention methods. This further limits the population's choices for protection.

Common ailments and diseases such as the cold or flu are spread through everyday contact with others, as are many less-common and more life-threatening diseases like SARS and H1N1, which have become major epidemics in recent years. The result of such epidemics has been widespread panic, with people rushing to protect themselves. Protection and prevention have been key factors in the development of different medical tools that are made readily available to the public; however the different forms of treatment have remained relatively constant, with few variations in design, type and intake method. Individuals generally function on a day-to-day basis in close proximity to others, whether it is in schools, offices, at home or while traveling and are exposed to a variety of airborne diseases; often individuals take special, somewhat inconvenient precautions.

Treatments for the different symptoms of the common cold, flu or any other disease with similar symptoms have remained relatively similar, with pill, liquids or any combination thereof being offered to treat common problems including, but not limited to, congestion, coughing, runny nose, sinus pressure, sneezing, body aches as well as general feelings of unwell.

In addition to the public's growing concern with the spread of contagious diseases and how to treat and/or prevent their spread, we are constantly faced with harmful pathogens and other germs in the air. On a daily basis, people are exposed to harmful materials like smoke, smog, allergens, pathogens airborne bacteria and foul odors. The majority of the population does not take steps to address these problems, instead viewing them as normal, everyday issues. Various allergy medicines and other treatments have been made available to the public, however again the options are limited and focus mainly on treatment of the problem and not on prevention. For persons who have difficulties with taking pills and who are uneasy with the liquid medicines that often contain a variety of different chemicals as well as alcohol, they are left with almost no other option to help themselves feel better

The present invention addresses problems with possible side effects quickly and efficiently. Commonly, drugs are either injected or ingested and many individuals experience side effects. These individuals are forced to either wait for the effects to subside or seek medical treatment. The present invention allows individuals suffering from side effects to quickly treat themselves by immediately removing the mask the individual is no longer exposed to the treatments and can consult a medical professional regarding a person's side effects while being free of further problems. The present invention is an effective alternative, using a pulmonary drug delivery system in which individuals are administered treatments through inhalation. Inhalation systems have proven to be extremely beneficial in the administering of drugs as it has been determined that inhalation methods are just as effective as injection; such examples of successful inhalation treatments include treating asthma, and more recently—breathable insulin.

3. Description of Prior Art

A mask and scarf combination to protect individuals from outside threats, is described in U.S. Pat. No. 5,214,804, which offers a facial form-fitting mask and is combined with a scarf to protect individuals from outside air-borne threats. However, this mask-scarf combination is not meant to be an everyday, fashionable garment nor does it include the option of an interchangeable, treatable and disposable filter. Similarly, U.S. Pat. No. 7,107,628 describes an article that is not for everyday use. Instead it is intended for emergency situations. It also solely acts as a filter, filtering the surrounding air mechanically, electronically or chemically with no mention of a treatment system. This differs from the present invention, which calls for a disposable filter that does not rely on help from electricity, motors or chemicals. Additionally, U.S. Pat. No. 7,107,628 describes an article that is limited in that it cannot be configured as a piece of fashionable apparel nor does it offer the range of filtering or comfort options the present invention does.

In terms of design, a few different patents have been published addressing the design of different facial masks. Specifically, U.S. Pat. No. Des 369,442 outlines the design for a wearable mask that covers the entire lower part of the face as well as the neck area. The design claims that the mask is both a scarf and a filter, however the entire invention is not an every day piece of apparel. The design does not include treatable filters, nor does it offer the neck-rest option or the full facial cover up. Ultimately, the scarf aspect of the design is an inaccurate definition of the design and it is not a key element of the overall design. U.S. Pat. No. Des 349,782 also provides a design for a scarf, however the design features only a bandana with a filter and drawstring attached. This design does not offer the wide range of possibilities the present invention does, nor does it present itself as an everyday piece of clothing with various treatment options.

Additionally, U.S. Pat. No. 5,343,561 provides a system integrating a sleep mask with noise protection. The sole similarity between this invention and the present invention is the fastening technique. The present invention fastens around the face and/or neck in a variety of ways, including the method that is outlined in U.S. Pat. No. 5,343,561, which defines a drawstring method. Besides the method of fastening the mask, this patent and the present patent have nothing else in common besides the goal to provide comfort to its wearers. The present patent offers a variety of different fastening systems to secure the mask around the face, and include all possible fastening systems in the summary below.

Different facial filters and masks have been invented in the past, with a specific aim to prevent the spread of diseases, pathogens and other airborne bacteria and germs. There has yet to be a product that has the ability to treat an individual using a similar facial filter mask mechanism. In the past, the standard design surgical mask has been used as a barrier device to protect people from their surroundings. This system has been especially important in the medical field, to prevent the wearer from getting sick as well as protecting patients from contracting outside diseases or bacteria. Though these masks are useful, they do little to truly help the wearer, who may already be sick.

U.S. Pat. No. 4,790,307 describes a disposable surgical mask having a self-contained supply of anti-bacterial material. This patent outlines a device that appears as a standard disposable surgical mask containing an envelope that creates a holder for an ampoule device. This ampoule device holds an antibacterial liquid that sterilizes the air that is inhaled and exhaled by the wearer. By sterilizing the air, airborne pathogens and other germs are unable to affect the wearer, thereby protecting him or her from their potentially hazardous surroundings. U.S. Pat. No. 4,856,509, describes a facemask and method that prevents the spread of diseases such as the cold, the influenza viruses and other similar diseases. It provides an array of different configurations, which allows for a person to be protected from for diseases or other viruses. The mask is either coated, or contains an ampoule filled with a viral destroying chemical that kills airborne or mucus borne pathogens and bacteria.

These, and many other prior articles only focus on the protection from contracting a virus, harmful bacteria or pathogens. They do not provide the treatment of symptoms via filter or facemask, which is a key element of the present invention. Additionally, in recent years, researchers and scientists have discovered a way to deliver drugs through the respiratory system, the most notable example being breathable insulin, which may be used by diabetics. The benefits of a pulmonary drug delivery system are wide-ranging and suggest that there are alternatives for the medicinal delivery to individuals.

### BRIEF SUMMARY OF THE INVENTION

Accordingly, it is the object of the present invention to provide a personal air filtration apparatus. The apparatus can be provided as a versatile preventative and beneficial medical scarf apparatus that covers the neck, mouth, nose, ears and eyes, or any combination thereof. Additionally, the present invention includes a facial filter used individually or in combination with an article of clothing to provide any combination of protection, optional treatment and/or aromatherapy to the wearer. The filter may be worn individually across the face covering the nose and mouth, as well as inserted into or placed inside the larger scarf apparatus. The present invention is to help individuals protect themselves and others from the spread of illness and infections that may be contagious. The invention is also used in highly populated areas, around other individuals or groups of people who are sick or who may be sick, or in areas with hazardous air like smog, smoke or dander. To ensure a level of aesthetic variety, these filters as well as the scarf apparatus, are completely customizable. The outer layer of the filter and/or scarf, as seen by the public, can vary in different colors, logos, caricatures, cartoons and/or different faces, all depending on the wearer's personal style. The medical garment (scarf apparatus) also has the option of different colors, designs, logos, images, characters and/or caricatures as suitable for varying ages and styles. The present invention or any variation of the present invention may be used in areas that are polluted or that contain foul odors and may also be used in the food service/preparing industry as well as in the medical industry, thereby providing masks that are comfortable, easy to use and more effective than current masks used in these industries. Both parts of the invention can be used for a variety of different reasons, from general protection against one's environment to treatment for a particular symptom.

In one embodiment, the present invention is made up of two separate parts. First is the fashionable scarf apparatus, which may vary in size and color and may be worn around the neck to cover the neck, mouth, nose, eyes and/or ears of the individual, or any combination of the five. The second part is a removable, replaceable, optionally treatable filter, which can be worn individually, or can be incorporated into the fashionable scarf apparatus thus providing a combination of protection and treatment to the wearer.

The uses of the invention are many, however some specific examples include using it when an individual feels a threat to his/her immune system. The individual may lift the scarf and fasten it around the face, effectively covering the neck, nose, mouth, eyes or ears, or any variation of the five. In accordance with the present invention, the scarf apparatus contains a pocket and/or holder to conceal the filter. By fastening the scarf apparatus around the head in any acceptable manner including, but not limited to using ties, magnets, hook and loop fasteners (Velcro), buttons, snaps, and combinations thereof, the apparatus provides a barrier between the individual and any harmful bacteria, allergens and/or viruses that may be in his/her surroundings. In one configuration, the scarf apparatus contains a pouch in the back, in which a neck rest can be inserted for further relaxation when used. This neck rest is designed especially to fit within the present invention and can be completely enclosed within the apparatus. This neck rest aspect of the present invention is useful for those who are traveling on airplanes, in cars or on trains and hope to take a restful nap.

The user may opt to use the filter by itself, fastening it around the face by attaching it behind the ears and thereby treating oneself while protecting those around the wearer from contracting an infection. Some possible treatments for the filter include, but are not limited to brand name treatments like Vicks Vapor Rub®, TheraFlu®, Zicam® or Benadryl®, as well as other products. Additionally, generic products like Lavender, Menthol, Zinc, or any other aromatherapy or homeopathic treatment can be disposed on and/or within the filter of the present invention. The treatment method for the filter system includes a variety of different techniques, all of which allow the individual to breathe comfortably and with ease. The preferred method for the treatment of the filter is to dispose a material on and/or within the filter with treatment on one side, and seal the treated filter in an air tight package. When the air tight package is opened, the treated side is revealed, allowing the wearer to place the now exposed filter ‘activated’ by ambient air around his or her face or place it inside the scarf to inhale its medicinal and/or aromatic properties. The method of providing an inhalation is also provided by having a number of treated strips that are covered with an adhesive. Each adhesive covers a strip of treatment, that when opened, allows an increasingly more intense treatment. When the adhesive is removed, the treatment is exposed to ambient air and subsequently activated, however even when the adhesive is not removed, the treatment intensity does diminish over time. This method allows people to control the strength of their treatment, uncovering all the strips makes it stronger, while only one or two strips revealed mean a more subtle treatment. Another treatment system for the filter is to incorporate plastic ampoules between the layers of filter material, which contain the treatment or aroma. In this form, the treatment and aromas are in liquid or gel form and are released and absorbed into the surrounding sterile gauze or cotton when pressure is applied to the filter and/or ampoules inside. To properly release the liquid or gel, the individual can provide pressure or when the filter is opened fully, the ampoules are broken. This also allows for individuals to control the strength of their treatment, as they can break a few ampoules for a less strong effect, or all of them for a stronger effect. Another system is a dilution process, in which as each treatment is opened, ampoules or bladders of water can be burst to systematically dilute the treatment, thereby making it less strong according to the user's desire. Another form of the present invention is a spray or any other type of application device including but not limited to a liquid, solid or gel roll- or rub-on, or a liquid dip that may be applied directly to the mask upon manufacturing. In these formats, individuals have control over the quantity and or strength of their treatment and therefore the power to treat their systems themselves and according to how their body feels. The present invention also includes a system in which the treatments provide a level of moisture to the wearer, thereby moistening the nostrils and throat during inhalation; there are areas that are often extremely sensitive and tend to dry out when an individual is suffering from congestion, runny nose, coughing and sore glands. These treatment methods also apply to the aromatherapy option of the present invention, thereby allowing for treatment and/or aromas to be placed on or in the filter. On a separate note, to further protect wearers, the filter can also contain carbon, charcoal or any other type of filtration element to protect against smoke, dander or other foul smells. In addition to methods to treat the filter, the structure of the filter can take on a few different forms. One form is comprised of layers of nonwoven filter paper, inside of which are a few layers of sterilized cotton and/or gauze that absorb the liquids that are incorporated into the filter. Another form is to have the entire mask absorb the treatment into the filter.

The filter has a variety of different fastening options to remain secure within the main scarf apparatus. One attachment system includes having the outside of the filter covered with an apparel-friendly adhesive, allowing it to be stuck to the inside of a scarf, in addition to being placed within a pocket in the scarf, thereby ensuring the stability of the filter while inside the scarf. Other fastening methods include but are not limited to snaps, magnets, hook and loop (Velcro®), ties, and soft hook and loop (Velcro®) as used on disposable diapers and described in U.S. Pat. No. 6,406,467 B1, which describes an adhesive Velcro system that fastens to cloth easily and comfortably. Therefore, the invention in its entirety acts as a barrier method, it provides treatment for the symptoms individuals often suffer from during the cold and flu season, either with medicine or naturally and, it provides pleasant odors to the user while acting as a fashionable, everyday article of clothing. The filter apparatus provides an option that is affordable, easy to use and convenient for those who lead regular, active lives without being further debilitated by their symptoms. With no age-specification, the apparatus may be used by anyone and is especially helpful to those who live, work or spend a considerable amount of time in close proximities with other people.

The apparatus allows people to protect themselves and others, similar to any other filter mask, where airborne pathogens, bacteria, allergens and other germs are unable to affect the wearer. Not only does the filter protect the wearer from his or her potentially hazardous surroundings, the scarf apparatus along with the filter protects the general public by acting as a barrier between the wearer who may be sick or contagious, and the rest of the population. Therefore, when a person is experiencing symptoms, he or she may use the filter to cover their nose and mouth, thus protecting the public from exposure while allowing the individual to continue with his or her daily activities. Though this aspect of the invention is fairly similar to other masks available today, the treatment factor, which functions simultaneously with the protective apparatus, sets it apart from any other filter. The present invention will be a staple in everyday life for students, travelers, and shoppers as well as in the food service/preparation industry, public works industries, and among airline staff, sport events, in mass transit and in hospitals among doctors, nurses, families and pregnant women. Additionally, the present invention will be common in hotels, at ski resorts, theme parks, racetracks, casinos, and cruise ships. Ultimately, in any place where there is possible contact with the public, there is a demand from individuals who want to be able to protect themselves and their loved ones.

The apparatus allows individuals to utilize it for protection, as a health benefit and as a medical device. Additionally, the scarf apparatus provides a space for an optional neck support device and offers full facial coverage for further comfort. The filter supported by the main body can provide medical or soothing treatment for various symptoms as well as act as a system to filter out harmful pathogens. In its entirety, the scarf apparatus acts as a barrier system between the wearer and the public while the filter apparatus serves as a treatment system for the wearer. The filter may be used separately as a barrier and/or treatment system, or incorporated into the scarf apparatus, thereby forming a reinforced barrier system along with optional treatment. More specifically, this invention in its entirety helps prevent the spread of, and provides treatment for common or less common diseases from the cold and influenza viruses to diseases such as SARS and H1N1. As a filter apparatus that can treat the wearer for any of the common symptoms related to illness, it also prevents the spread of diseases, germs, allergens and other pathogens in the air. The apparatus has the option of being a treatment method and/or a barrier method for individuals in any situation, from crowded public areas such as places of public transport, schools, offices, recreational areas both in- and outdoors, to the privacy of one's own home.

In one embodiment, the clothing article can be a “hoodie” known in the art as a t-shirt or sweatshirt with a hood attached on the rear of the collar. The hood is configured to be drawn forward over the head of the wearer and cover the eyes, nose and mouth of a user. A filter is affixed over either or both of the eyes and nose and sight openings for the eyes are incorporated into the hood.

In one embodiment, the present invention is an apparatus for providing personal respiratory filtration comprising:

a. a planer main body fabric apparatus constructed and arranged with a portion to be positioned over the neck, mouth, nose, ears and eyes, or combination thereof on an individual;
b. a respiratory filter dependent on said main body or independent of said main body

The apparatus said planer main body attaches around the face of a user and preferably extends completely around the head of a user.

The apparatus said planer main body has a securing mechanism for securing around the head of a user. The securing mechanism for securing around the head of a user can be any acceptable fastener and includes, but is not limited to a hook and loop fasteners (Velcro), zippers, buttons, snaps, combinations thereof and the like.

The filter is attached to the clothing article in a pocket, pouch, or in another formatted attachment or surface area available for placement to said planer body. The filter is attached with hook and loop fasteners, magnets, snaps, ties, adhesives, or combinations thereof.

Preferably, the filter is constructed and arranges such that it imparts a substantially planer orientation on said apparatus. The filter is incorporated into or onto the main body.

The filter is removable, changeable and treatable and is incorporated with a clothing article such that filter and article is constructed and arranged to be worn as an article of clothing.

In one embodiment, the combined filter and article is configured in a folded configuration to further function as a neck pillow.

The filter is constructed arranged such that is further incorporates a pharmaceutical active substance, a nutritional supplement, carriers for delivery, or combinations thereof.

In one embodiment, the clothing portion of the apparatus is worn over the ears, eyes, nose, mouth and neck of a person.

The apparatus filter face mask includes:

a) a system for protection containing charcoal or carbon to serve as a filter; and/or
b) a system for treatment containing a variety of different breathable treatments for different symptoms including but not limited to Menthol vapor, aromatherapy treatments, or cold and/or flu medicine.

The filter as a mask is worn individually around the face, fastened behind the ears or around the neck, or placed within a personal apparel/garment and in one embodiment provides treatment by incorporating

a) one or more plastic ampoules placed within the filter, surrounded by filter material and sterile gauze and/or cotton through which the treatment may be absorbed when ampoules are ruptured; or
b) providing a personal applicator of spray, liquid, gel, solid rub-on, roll-on, or combinations thereof, for manual application to said filter.

Additionally, the mask has an adhesive for removably affixing to various personal garments.

### BRIEF DESCRIPTIONS OF THE DRAWINGS

FIG. E-I is a continuous scarf incorporating a filter and shown around the neck of a wearer.

FIG. E-II is a continuous scarf incorporating a filter; the scarf has a first free end and a second free end, wherein each end is joined to affix around the head and/or neck of a user.

FIG. I-A is a continuous scarf incorporating a filter.

FIG. I-B is a continuous scarf incorporating a filter; the scarf has a first free end and a second free end, wherein each end has complementary snaps to affix around the head and/or neck of a user.

FIG. II-A is a continuous scarf incorporating a filter; the scarf has a first free end and a second free end, wherein each end is joined to affix around the head and/or neck of a user.

FIG. II-B is a continuous scarf incorporating a filter; the scarf has a first free end and a second free end, one free end has an opening in which the opposite end is passed to secure the scarf around the head and/or neck of a user.

FIG. III-A is a continuous scarf incorporating a filter; the scarf has a first free end and a second free end, wherein each end is joined to affix around the head and/or neck of a user.

FIG. III-B-1 is a continuous scarf incorporating a filter; the scarf has a drawstring to secure around the head and/or neck of a user.

FIG. III-B-2 is a continuous scarf incorporating a filter; the scarf has a first free end and a second free end, wherein each end has complementary magnets to affix around the head and/or neck of a user.

FIG. IV-A is a shirt with a pouch and filter incorporated thereon.

FIG. E-2 is a side view of a continuous scarf incorporating a filter and shown around the neck of a wearer.

FIG. E-3 is a side view of a continuous scarf incorporating a nose filter, a mouth filter, and a throat filter, and shown around the neck of a wearer.

FIG. E-4 is a side view of a continuous scarf incorporating a nose filter, a mouth filter, a throat filter, and an ear filter and shown around the neck of a wearer.

FIG. E-5 is a side view of a continuous scarf incorporating a nose filter, a mouth filter, a throat filter, an ear filter, and an eye filter and shown around the neck of a wearer.

FIG. E-6 is a side view of a continuous scarf incorporating a string tie securing configuration and shown around the neck of a wearer.

FIGS. V-A and VI-A show a side view of a neck rest incorporated into the scarf.

FIGS. D-I and D-II show a perspective view of the filter with material disposed on the filter fiber.

### DETAILED DESCRIPTION OF THE PREFERRED EMBODIMENT

The present invention is for a personal filtration apparatus configured of two separate parts, the personal scarf apparatus 12 and the filter apparatus 17. The scarf or apparel apparatus 12 also includes a space for a removable, specially designed neck rest 30, as seen in FIGS. V. A and VI. A for further optional comfort. The filter 17 location on the apparel may vary, but the scarf apparatus 12 will have an attached pouch or pocket 11 for housing and holding the treatable filter. Additionally, in one embodiment, the apparel 12 will have a holder that can be filled with a neck rest 30, while being worn and/or used as a filter system. The filter 17 can be removed and replaced as necessary. The device is fastened around the individual's head in multiple securing device manners. Additionally, the apparatus can also be used as an everyday accessory.

As seen in FIG. E-I, a one piece scarf 12 is provided. FIG. E-II depicts a scarf 13 having open ends wherein a user 10 can tie the open end scarf 13 into a securing position. FIG. II-A shows the open end scarf 13 configured to be tied. FIG. II-B shows a configured scarf 14 with an incorporated opening therein for slipping one end through the opening and securing the scarf 14. FIG. I-B provides a snap-configured scarf 15 with a plurality of snap fasteners 16 for securing scarf 15 into position. FIG. IV-A shows filter pouch 11 incorporated into a shirt.

FIG. E-2 shows scarf 12 around the neck of a wearer. FIG. E-3 shows scarf 21 incorporating separate filters being a nose filter 24, mouth filter 23, and throat filter 22. FIG. E-4 show scarf 25 with nose filter 24, mouth filter 23, and throat filter 22, and ear filter 25. FIG. E-5 further provides a scarf 28 with an eye filter 27. In each of FIGS. E-3, E-4, and E-5 each of nose filter 24, mouth filter 23, throat filter 22, ear filter 25, and eye filter 27 are attached to the respective scarf either in a pouch, as described above, or other suitable attachment means. In an embodiment shown in FIG. VI-A, securing tie strings 29 are provided to tie the scarf into position.

FIGS. D-I and D-II show a filter assembly 35 with loops to fasten about the ears of a wearer. Filter surface 37 has a material 38 disposed thereon. It is contemplated that any acceptable disposition method or processed is encompassed in the present invention and includes but would not be limited to, coating material on filter surface 37, weaving fibers into surface 37, impregnating fibers of surface 37 combinations thereof, and the like.

The apparatus provides for a combination of fashion and function by allowing for a variety of different filters 17 including, but not limited to, antibacterial filters, allergy filters, smoke/smog filters, scented filters as well as filters with medicinal components incorporated thereon for the administration of medicines. The present invention is more comfortable to wear, contrary to the conventional mask, such as the painter, doctor, and nurse mask. The present conventional masks do not hang around the neck uncomfortably nor do they need to be secured uncomfortably around the ears, thereby making them less bulky, easy to use and more aesthetically pleasing.

Any size shape of device as cloth or apparel and used with a filter attached or pocket for breathing filter 17.

The filter system includes a wide range of treatment options. These options include but are not limited to:
I. A dipping system in which the filter is immersed in the treatment and then immediately packaged and sealed tightly. The product is activated when the packaging is opened.
II. A system in which the filter contains layers of sterile cotton gauze or similar. Around the layers are ampoules which when pressed individually; they release the treatment to be absorbed into the gauze.
   a. a variation of this is to have the ampoules filled with water or another substance that prolongs the effects of the treatment, which are burst and mixed with already present strips of treatment.
   b. For all options, the level of intensity for the treatment is regulated by the user, each person can decide how strong their treatment should be depending on how many ampoules are broken.
III. The filter contains strips that are covered with adhesives. When the adhesives are removed, each strip is activated (as described above). For this option, the packaging would seal the entire filter as well as the individual strips of treatment on the filter.
IV. Treatments can be in liquid form and sprayed over the filter, thereby effectively covering or disposing the filter with treatment in or on the filter. The packaging system would be similar to previous ideas, in which it would tightly seal the product, only to be active when opened by the user.
   a. a variation of this application process includes a roll-on process in which a certain area of the filter is covered with treatment and then immediately sealed with adhesive. This technique would be especially beneficial if the product had strips of treatment that were then covered with adhesive.

The packaging designs for the filter individually includes vacuum sealed plastic, adhesives that cover the treated part of the mask with an overall plastic wrapping that covers the entire filter; or complete a plastic adhesive that covers the entire mask.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An apparatus for providing personal respiratory filtration comprising:
a. a planer main body fabric apparatus constructed and arranged with a portion to be positioned over the neck, mouth, nose, ears and eyes, or combination thereof on an individual;
b. a respiratory filter dependent on said main body or independent of said main body

2. The apparatus of claim 1 where in said planer main body attaches around the face of a user.

3. The apparatus of claim 1 wherein said planer main body extends completely around the head of a user.

4. The apparatus of claim 1 wherein said planer main body comprises of a securing mechanism for securing around the head of a user.

5. The apparatus of claim 1 wherein said planer main body comprises or consists of a securing mechanism for securing around the head of a user being hook and loop fasteners, zippers, and the like.

6. The apparatus of claim 1 wherein said filter is in a pocket, pouch, or in another formatted attachment or surface area available for placement to said planer body, said filter is attached with hook and loop fasteners, magnets, snaps, ties, adhesives, or combinations thereof.

7. The apparatus of claim 1 wherein said filter in said planer main body imparts a substantially planer orientation on said apparatus.

8. The apparatus of claim 1 wherein said filter is incorporated into or onto said main body.

9. The apparatus of claim 1 wherein said filter is removable, changeable and treatable.

10. The apparatus of claim 1 where in the apparatus is constructed and arranged to be worn as an article of clothing.

11. The apparatus of claim 1 wherein the apparatus is configured in a folded configuration as a neck pillow.

12. The apparatus of claim 1 wherein said filter incorporates a pharmaceutical active substance, a nutritional supplement, carriers for delivery, or combinations thereof.

13. The apparatus of claim 1 wherein said apparatus is worn over the ears, eyes, nose, mouth and neck of a person.

14. The apparatus of claim 8 in which a filter face mask including
a) a system for protection containing charcoal or carbon to serve as a filter
b) a system for treatment containing a variety of different breathable treatments for different symptoms including but not limited to Menthol vapor, aromatherapy treatments, or cold and/or flu medicine.

15. A mask in accordance with claim 14, wherein said mask may be worn individually around the face, fastened behind the ears or around the neck, or placed within a personal apparel/garment as described in claim 1.

16. A mask in accordance with claim 14, wherein said mask provides treatment by incorporating
a) one or more plastic ampoules placed within the filter, surrounded by filter material and sterile gauze and/or cotton through which the treatment may be absorbed when ampoules are ruptured; or
b) providing a personal applicator of spray, liquid, gel, solid rub-on, roll-on, or combinations thereof, for manual application to said filter.

17. A mask in accordance with claim 14, wherein one side of said filter has an adhesive for removably affixing to various personal garments.
